(19) United States
(12) Patent Application Publication
(10) Pub. No.: US 2012/0272176 A1
(43) Pub. Date: Oct. 25, 2012

(54) Persistent User Interface for Providing Navigational Functionality

(75) Inventors: Tom Nielsen, Newark, CA (US); Sanjeev Singh, San Francisco, CA (US); Joe Sriver, Mountain View, CA (US)

(73) Assignee: GOOGLE INC., Mountain View, CA (US)

(21) Appl. No.: 13/529,555

(22) Filed: Jun. 21, 2012

Related U.S. Application Data
(63) Continuation of application No. 10/702,120, filed on Nov. 5, 2003, now abandoned.

(51) Int. Cl. G06F 3/048

(52) U.S. Cl. 715/779

(57) ABSTRACT

A method and apparatus, including a graphical user interface, for allowing quick processing of queries, including display of results, without requiring opening of a traditional browser program application window. Queries may be input and processed directly from a persistent or otherwise on-demand query input area, without the need to open a browser or other program separately for entering/processing a query, navigating to a search engine or particular document, etc. A number of query types may be supported by the user interface of the present invention, such that depending on a particular query type selected for/indicated by a query, a particular information retrieval mechanism processes the query to obtain one or more results. An on-demand result window is generated in response to a query request to output one or more results obtained in response to a given query.

### CROSS-REFERENCE TO RELATED APPLICATION

This application is a continuation of U.S. patent application Ser. No. 10/702,120, filed on Nov. 5, 2003, the contents of which are incorporated herein by reference in their entirety.

### BACKGROUND OF THE INVENTION

1. Field of the Invention

The present invention relates generally to graphical user interfaces for information retrieval mechanisms (e.g., search engines), and more particularly, to a method and apparatus for providing on-demand access to search and other navigational functionality by providing an on-demand query area on a desktop area of a computing device's user interface and generating an on-demand result window to display one or more results obtained in response to a query input to the query area.

2. Background

Increasingly, people depend on electronic document databases, such as the World Wide Web (“web”), to store and/or retrieve information. The web includes a number of interconnected “server” systems which store and make available information. Typically, a user of a “client” system may locate and access such information using an appropriate application that enables navigation (e.g., locating, viewing, linking between, etc.) of documents in the database. “Document” as used herein refers broadly to information in one or combination of various formats and media, and may include web sites, web pages, domains, search results, locally stored files/emails/other data, etc. Such documents may provide links to other documents in the database(s).

A browser program (“browser”), such as Microsoft's Internet Explorer (IE), is a well-known mechanism for allowing search, accessing, viewing, and navigation (collectively referred to herein as “navigating” or “browsing”) of web and other database documents. Using such a browser, a user may access a particular document, such as a web page, by entering the document's uniform resource locator (URL) or other document identifier into a navigation box. Users may also browse documents by using a search engine site, links from other documents, a “bookmarked” list of favorite documents, etc.

A popular mechanism for browsing documents in a database such as the web is a search engine. Search engines typically return hyperlinks to documents (e.g., web pages) determined to be relevant to a user's interest, as indicated by a query. Generally, search engines base their determination of the user's interest on search terms (also called a search query) entered by the user. The goal of the search engine is to provide links to high quality, relevant results to the user based on the search query. Typically, the search engine accomplishes this by matching the terms in the search query to a corpus of pre-stored documents. In addition, depending on various criteria, such as the nature of search term occurrence(s) in a given document, the quality and quantity of links to that document, the extent of match between the search terms and anchor text associated with those links, a search engine may select the most relevant results and return them to the user.

To perform a web search, for example, users generally launch a browser program including its associated browser window, using the browser, navigate to a search engine site (e.g., www.google.com) and then enter their search query. In greater detail, the user would perform the following process: (1) launch a browser (or activate its window (if the program is already launched), including opening an active browser window that remains open on the desktop until closed or minimized by the user or “covered” by another application window; (2) navigate to a search site; (3) enter a search query into the query box provided by the search site; (4) request a search once satisfied with the entered query; (5) view and select between the search results provided by the search engine; and (6) minimize or close the browser window when finished.

In order to simplify this process, some “add-on” programs provide a “persistent” query box within a browser application window to provide virtually instant, on-demand access to search functionality. Once a browser is launched, no matter what document a user may be viewing within the browser window, the user may enter a query into the persistent query box and request a search. The Google Toolbar is a well-known mechanism for providing such functionality, including allowing users to enter search queries for processing by the popular Google search engine at any time from within a browser window without actually having to display the www.google.com site to do so. Thus, such search functionality could be accessed while a user is viewing any document in the browser window.

Additionally, alternative mechanisms have been proposed that provide a persistent query area on a desktop taskbar or menu bar of computer operating system's user interface to receive search queries and display results using a user's default browser program window. An example of such a system is Dave's Quick Search Taskbar Toolbar Deskbar (e.g., see http://notesbydave.com/toolbar/doc.htm)

Unfortunately, all of the above-described mechanisms require the user action to (1) open a browser program window to allow the user to enter queries or otherwise perform document browsing; and/or (2) close or minimize the browser program window once finished browsing, e.g., to save display resources.

Thus, what is desired is a method and apparatus for allowing a user to access navigational functionality, including entering queries and browsing one or more results returned in response thereto, without requiring the user to open or close a traditional browser program window.

### SUMMARY OF THE INVENTION

In accordance with one aspect of the invention, an on-demand query processing mechanism is provided, which may include an on-demand (e.g., persistent) query input area in which queries may be entered.

In accordance with another aspect of the invention, an on-demand result window is generated in response to a query request to output one or more results obtained in response to a given query, and optionally is hidden when a user accesses other windows, functionality, etc.—i.e., when the result window loses focus.

In accordance with yet another aspect of the invention, a fill-in query box or other input area (e.g., a navigation bar of a browser, a persistent query box, etc.) may display or otherwise output static or dynamic “background” information when not the input are is not in focus.

### BRIEF DESCRIPTION OF DRAWINGS

FIG. 1 is a diagram illustrating an exemplary system in which concepts consistent with the present invention may be implemented;

FIG. 2 is an exemplary diagram of a client or server entity (hereinafter called “client/server entity”), which may correspond to one or more of clients 110 and servers 120-140 shown in FIG. 1, according to one embodiment of the invention;

FIG. 3A is a diagram of an exemplary user interface that includes a persistent query area on a desktop and may be implemented by a computer system, such as client 110 in FIG. 1, according to one embodiment of the invention;

FIG. 3B is a diagram of the exemplary user interface shown in FIG. 3A, further including an on-demand result window, according to one embodiment of the invention; and

FIGS. 4 is a flow diagram of a method for providing a persistent query area and on-demand result window (collectively, an “on-demand information retrieval interface” or simply “IR interface”) for a computer user interface, in accordance with one embodiment of the invention.

### DETAILED DESCRIPTION

The present invention provides a convenient user interface for facilitating search or other navigational functionality across one or computer systems, document databases, data storage areas, networks, etc. (collectively, “document databases”), which may or may not include the web. In accordance with one aspect of the invention, a persistent or on-demand query area is provided via a taskbar, menu bar, or other portion of a desktop area of a user interface. The query area may allow search queries, document/URL requests, and other types of queries to be entered at any time, without requiring the step of launching or otherwise accessing a browser program window. In accordance with another aspect of the invention, one or combination of content (e.g., graphics/logo, animation, video, ads, etc.) may be displayed in the query area when it is not being used or another application window is in use by a user (i.e., when the persistent query area is not in focus). In accordance with yet another aspect of the invention, in response to queries entered in the (persistent) query area, an “on-demand” navigational result window is generated to display or otherwise output one or more results.

The result window is “on-demand” in the sense that it is opened automatically in response to queries requested via the persistent query area to output one or more results, and is automatically closed (i.e., hidden from the desktop) when a user's focus is detected elsewhere (e.g., the user clicks other functionality or windows). In contrast to a traditional (browser) program window that remains open until minimized, closed or dominated by another application window, the present invention provides quick entry and processing of queries (via a persistent or on-demand query input area) and display of results in response thereto until user focus is detected elsewhere. As such, the present invention does not require a user to launch a browsing program window to perform queries or display results, or even to close such windows when the user switches focus to (e.g., provides mouse hovering, clicking, or typing in) other applications windows, desktop icons or accessories, or other functionalities.

Other aspects, features and benefits of the invention will be apparent from the following description of exemplary embodiments thereof.

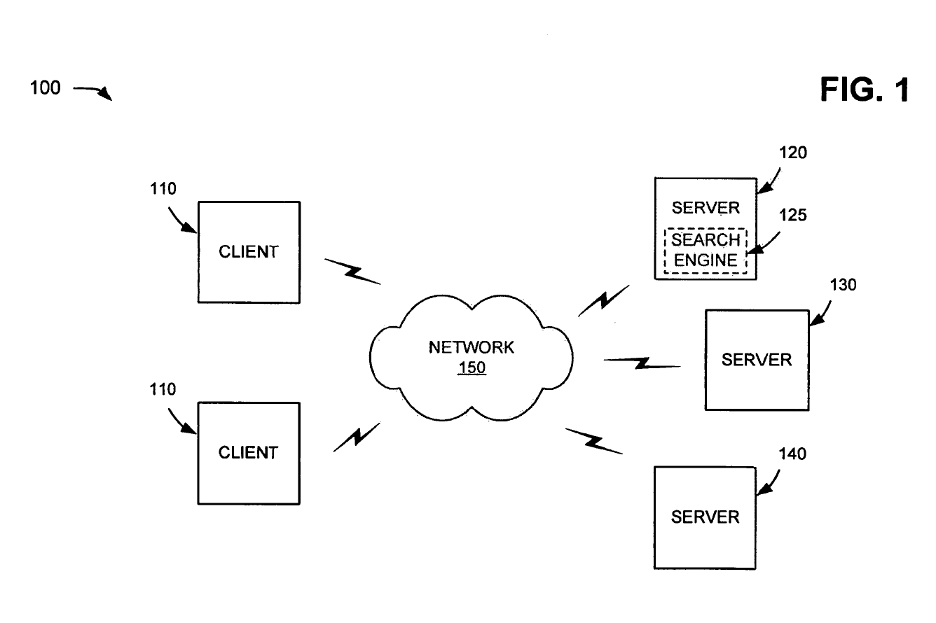

FIG. 1 is an exemplary diagram of a network 100 in which systems and methods consistent with the principles of the invention may be implemented. Network 100 may include multiple clients 110 connected to multiple servers 120-140 via a network 150. Network 150 may include a local area network (LAN), a wide area network (WAN), a telephone network, such as the Public Switched Telephone Network (PSTN), an intranet, the Internet, a memory device, another type of network, or a combination of networks. Two clients 110 and three servers 120-140 have been illustrated as connected to network 150 for simplicity. In practice, there may be more or fewer clients and servers. Also, in some instances, a client may perform the functions of a server and a server may perform the functions of a client.

Clients 110 may include client entities. A client entity may be defined as a device, such as a wireless telephone, a personal computer, a personal digital assistant (PDA), a lap top, or another type of computation or communication device, a thread or process running on one of these devices, and/or an object executable by one of these devices. Servers 120-140 may include server entities that gather, process, search, and/or maintain documents in a manner consistent with the principles of the invention. Clients 110 and servers 120-140 may connect to network 150 via wired, wireless, optical or other types of network connectivity technologies.

In one embodiment of the invention, server 120 may optionally include a search engine 125 usable by clients 110. Server 120 (and/or other servers, such as servers 130 and 140) may also provide a number of specialized query types to clients 110. For example, as described below with reference to exemplary embodiments of the invention, users of clients 110 may use a persistent query mechanism, including an on-demand result window, to process queries involving an address (or map) or phone number, search for local weather reports, search for software downloads, movie show times or reviews, products (using a specialized search engine or database, such as www.ebay.com or www.froogle.com), stock quotes, sports, news, dictionary/thesaurus or other reference (e.g., Google Answers), user groups, images (e.g., Google image search), or general web search (e.g., as provided at www.google.com) and/or or other types of queries. As detailed below, one or a combination of such query types may be conveniently accessible via a persistent, on-demand information retrieval mechanism provided (at least in part) on a client 110.

As such, the servers 130 and 140 may each provide one or more documents and/or information retrieval mechanisms accessible via the network 150. The information provided by the servers 130 and 140 may be crawled by the search engine 125.

While servers 120-140 are shown as separate entities, it may be possible for one or more of servers 120-140 to perform one or more of the functions of another one or more of servers 120-140. For example, it may be possible that two or more of servers 120-140 are implemented as a single server. It may also be possible for one of servers 120-140 to be implemented as multiple, possibly distributed, computing devices.

### Exemplary Client/Server Architecture

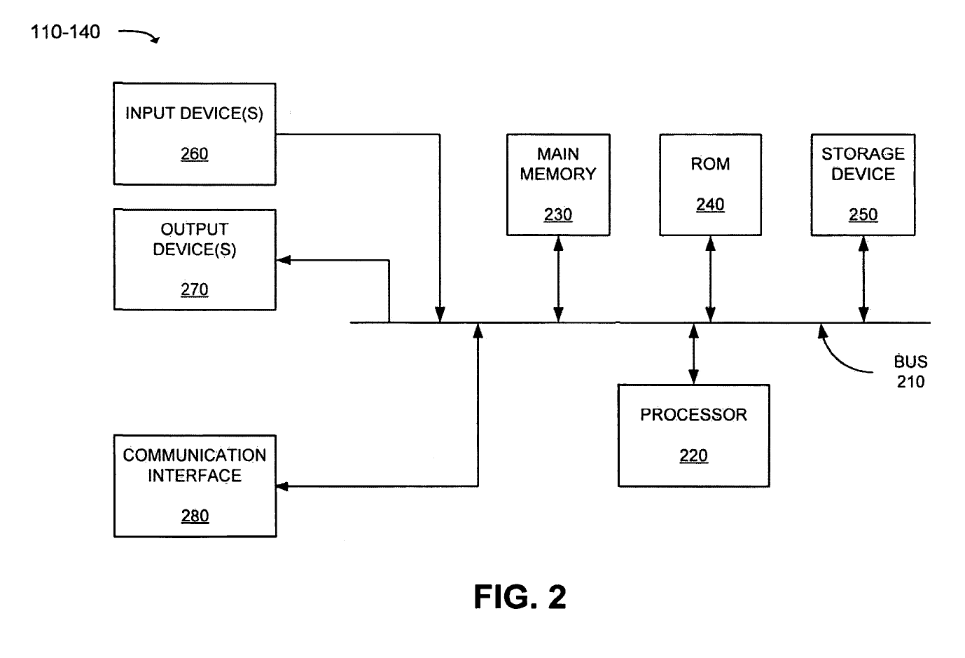

FIG. 2 is an exemplary diagram of a client or server entity (hereinafter called “client/server entity”), which may correspond to one or more of clients 110 and servers 120-140, according to one embodiment of the invention. The client/server entity may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity.

Processor 220 may include one or a combination of conventional processors or microprocessors that interpret and execute instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive. It should be appreciated that one or more of these data storage components may be omitted or combined in the client/server entity shown.

Input device(s) 260 may include one or more conventional mechanisms that permit an operator to input information to the client/server entity, such as a keyboard, a mouse, a pen, voice recognition and/or biometric mechanisms, etc. Output device(s) 270 may include one or more conventional mechanisms that output information to the operator, including a display, a printer, a speaker, etc. Communication interface 280 may include any transceiver-like mechanism that enables the client/server entity to communicate with other devices and/or systems. For example, communication interface 280 may include wired or wireless mechanisms for communicating with another device or system via a network, such as network 150.

The client/server entity will typically include an operating system (e.g., a Microsoft Windows or Mac OS operating system or some other operating system) that typically provides a graphical user interface including a “desktop,” which may include taskbars and “explorer” functionalities for the operating system. As described in further detail below, in one embodiment of the invention, a client system 110 may include a novel mechanism by which an area of the desktop is enhanced with a persistent or on-demand query area from which quick access to various search or other navigational functionalities may be provided to a user of the client system 110. In response to a search or other navigational query command received from a user in the query area, the mechanism further generates an on-demand navigational result window from which to return a result for output to the user.

The client/server entity may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. The software instructions contained in memory 230 causes processor 220 to perform one or more processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

Exemplary User Interface Configurations

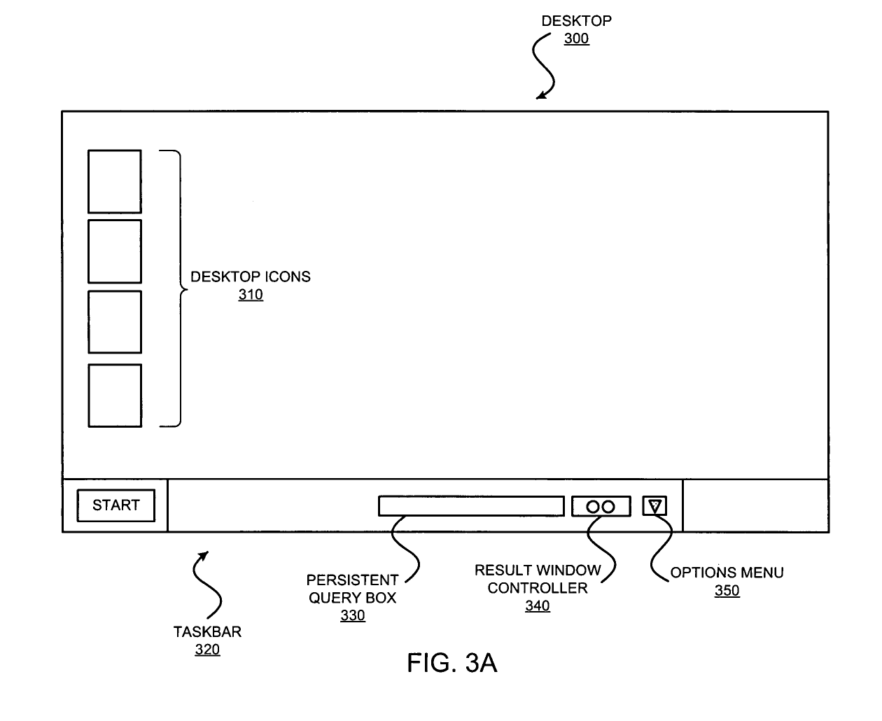

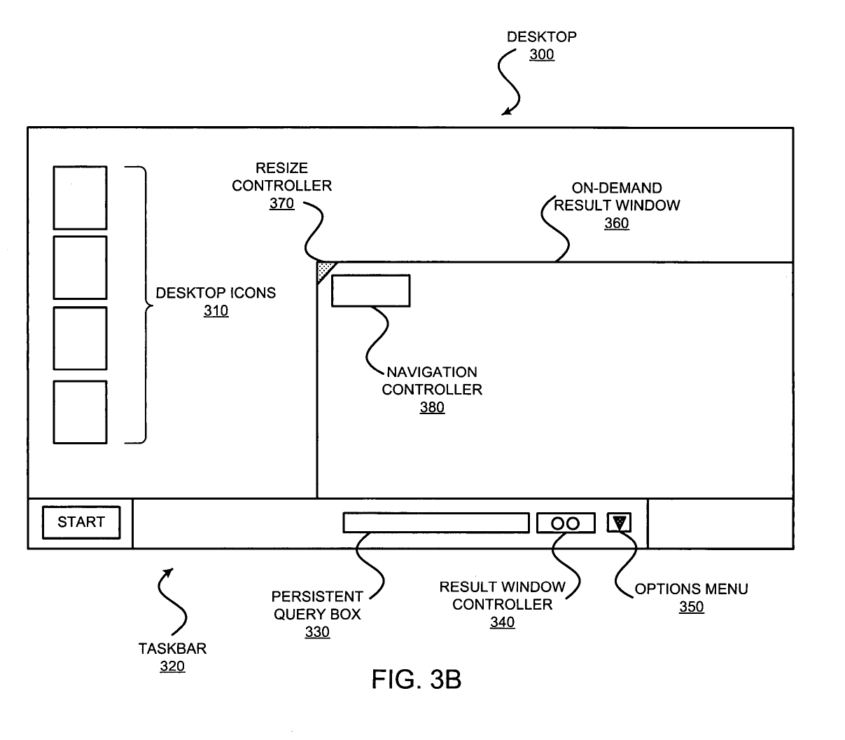

FIG. 3A is a diagram of an exemplary user interface that includes a persistent query area on a desktop and may be implemented by a computer system, such as client 110 in FIG. 1, according to one embodiment of the invention. A desktop 300 is shown and represents any desktop provided by a computing device operating system graphical user interface, including without limitation the Microsoft's Windows, Apple (Mac's) OS, mobile/portable device operating system or other operating system. Thus, it should be appreciated that the diagrams shown in FIGS. 3A and 3B are illustrative only, and are not meant to limit the invention to any particular operating system or graphical user interface configuration for a desktop.

The desktop 300 may provide one or more desktop icons, which may represent one or a combination of applications, files, directories, folders, etc. The exemplary desktop 300 includes at least one menu bar or taskbar 320. As generally known by those skilled in the art, the taskbar 320 may provide various graphical buttons, icons, menus, open applications, clocks/dates, and other information and functionality.

In the exemplary embodiment depicted in FIG. 3A, the taskbar 320 is shown horizontally at the bottom of the desktop 300. However, it will be appreciated that the taskbar 320 may be displayed in various parts of the desktop (e.g., horizontally at the top of the desktop 300, or vertically at a side of the desktop, etc.). Typically, the taskbar 320 is persistent—i.e., a user may view it and access its functionality regardless of whether any applications are running and their associated windows, if any, displayed or not. However, a user may be able to “hide” the taskbar (and its various tools) and access it on-demand (e.g., very quickly, using a hotkey or mouse drag, etc.). Furthermore, the taskbar 320 may dominate other windows and applications, such that other applications/windows cannot obstruct the taskbar 320 from being displayed, and its functionality accessible, to a user.

In one embodiment of the invention, the operating system with which the taskbar 320 is associated is enhanced by a mechanism that generates a persistent query area or “box” 330 within the taskbar 320. The persistent query area 330 is “persistent” to the extent it, or a portion thereof, is always present on the toolbar (or other part of the desktop that generally remains displayed to a user, regardless of whether and how many applications windows are open). It will be appreciated that in alternative embodiments of the invention, the persistent query box 330 may be provided outside a taskbar/in other parts of a desktop, a floating window or may be “hidden” and displayed upon one more user commands. For example, in one alternative embodiment, a query area may be hidden (but running “in the background”) and only displayed when one or a combination of hotkeys are input by a user, an icon (e.g., on the taskbar) is selected, etc.

The persistent query box 330 may be implemented, in one embodiment of the invention, as a Microsoft Windows Band Object which is displayed in the Windows operating system's taskbar. As such, the persistent query box 330 may be a DLL that includes a set of COM objects registered with Windows, and thus runs in Windows Explorer. In alternative embodiments, it should be appreciated that the query box of the present invention may be implemented in other operating systems.

In accordance with another aspect of the invention, “background” information may be displayed in the persistent query box 330, for example, when the persistent query box is not in focus (e.g., when a user accesses other applications/is not using the persistent query box). In one embodiment, the background information includes objects, such as graphics, such as a logo, which appears in the persistent query box 330 when the persistent query box 330 is not in focus, and which disappears once input, a cursor or other activity is detected in the persistent query box. In another embodiment, animation/video, advertisements, or other dynamic content may be provided in the persistent query box 330, for example, when it is not in focus.

As will be described in further detail, a user may enter queries of various types using the persistent query box 330. Depending on the type of, and responsive to, a particular user query, a result may be generated by the on-demand query mechanism and output in an on-demand result window that is displayed in response to the query request. It will be appreciated that “query” as used herein, unless expressly specified otherwise, refers broadly to any input of information responsive to which one or more mechanisms retrieve information determined to be relevant to the query and return one or more results. A typical query is one or more search terms, based upon which a search engine may return one or more results determined to be relevant to the query. However, a query may also include a request for a stock price, retrieval of a particular document (e.g., based on a query that includes a particular URL associated with the requested document), weather report, map/address request, movie show time, a search for an application, file or email stored locally, or a variety of other types user input in response to which the user expects, and the navigational mechanism provides, retrieval of (relevant) information, and which may or may not use (web) search engine.

In one embodiment of the invention, the persistent query box 330 may have associated therewith (e.g., via an options menu, as described below) a feature for resizing the persistent query box 330 depending on whether it is in use/focus or not. The resize feature, for example, may allow a user to define an active size for the persistent query area 330, the active size corresponding to the size of the persistent query area 330 when the query area is in focus. Instead or in addition, the feature may allow the user to resize the query area to an inactive size when the query area is out of focus. The inactive size of the persistent query area 330 is smaller than the active size. In one embodiment, the resize amount (for active and/or inactive) is preset to one or more sizes. In another embodiment, the user may define one or both of the active and inactive size of the persistent query area. The size of the persistent query area 330 may be toggled between the active size and the inactive size depending on whether the query area is in or out of focus, respectively. Focus, as used herein, may be based on various activity concerning an application window, menu, icon or other user interface, and may include without limitation one or a combination of mouse hover, mouse clicking, typing or other “input” with respect to a window, menu, icon, etc.

In one embodiment of the invention, associated with the persistent query box 330 are a result window controller 340 and an options menu 350, both of which are accessible via the taskbar 320. The result window controller 340 controls an on-demand result window, which will be described in further detail with reference to an embodiment thereof depicted in FIG. 3B. For example, in one embodiment of the invention, the result window controller 340 includes a graphical icon provided on the taskbar 320 that controls opening (displaying) or closing (hiding) the on demand result window, for example, when mouse-clicked.

In one embodiment of the invention, the options menu 350 provides a number of query options and configuration options. The query options allow different types of queries to be processed by one or more information retrieval mechanisms, wherein each information retrieval mechanism is configured to handle one or a combination of query types. For example, one query type may be a generalized web search performed based on search terms entered in the persistent query box 330. The web search may be performed by a general web search engine, for example, as provided at www.google.com. In one embodiment, one or a combination of other query type options may be provided, including without limitation a LAN/intranet search, a weather report (based on location information, such as a zip code, city, etc., entered as search terms in the query box), a search of one or more software downloading sites, movie review search, a product search of an auction site (e.g., ebay) or product search engine (e.g., www.froogle.com), stock quote, thesaurus, dictionary, Google Answers, breaking news, user groups, image search (e.g., Google image search), document retrieval request (e.g., by detecting a URL or other document address information in a given query, for example, beginning with “http://”), a “top result return” web search (e.g., as provided by the “I'm feeling lucky” option of a Google web search at www.google.com), and/or other query options. As will be appreciated by those skilled in the art, different types of query-processing mechanisms, each of which may be provided by one or more server systems, such as the server systems 120-140 shown in FIG. 1, may power the persistent query box 330, each corresponding to and for servicing a particular query option that may be selected.

In one embodiment, the query options may be configured by a user and/or a domain. For example, in a corporate environment that maintains a private network (e.g., an intranet), the administrator of that corporate domain may customize the query options, for example, to allow search of the intranet (e.g., an employee list, department pages, etc.). Also, users may be able to add or delete certain query options and thereby customize the query options menu.

In addition to, or instead of, a query options menu, one or more keyboard shortcuts (i.e., hotkeys, which may be predefined or customizable by a user) may allow a user to select a query type. For example, by detecting the keystroke combination such as “CTL+G”, a general web search may be performed on the query term entered in the persistent query area.

In one embodiment, a general web search is the default query option (unless a document retrieval request is detected). In one embodiment, a user's query request is executed when the user enters one or more search terms in the persistent query box 330 and then presses the return/enter key on the keyboard; if the shift button is held while the return/enter key is pressed, the default query type (in one embodiment, a general web search, e.g., using the general Google web search engine at www.google.com) will be performed and the result(s) shown in the on-demand result window.

In an alternative embodiment, there may be no options menu and/or query options may be specified in other ways. For example, a hotkey/function key may be used for a particular query type. Alternatively, in one embodiment, a user may enter a query type identifier within the persistent query (e.g., a set of characters) that specifies a particular query type (and corresponding information retrieval mechanism); for example, the character string, “froogle:” followed by a search term(s) may specify that a product search using www.froogle.com should be used, or “stock:” followed by a stock exchange symbol might specify a stock quote using a stock lookup information retrieval mechanism is requested.

As mentioned, the options menu 350 may further include one or more configuration options for the use interface of the present invention. In one embodiment, the configuration options may, for example, allow a user to do one or more of the following: select between using an on-demand result window to display one or more results or using a browser (window); opening a selected result in the on-demand result window versus a separate browser window; using a global search hotkey(s) to automatically capture text typed in virtually any application or file and enter it into the persistent query box 330 to be used as (part of) a search term(s); lock the minimum size of the on-demand result window; having the on-demand result window “animated,” such that it is a popup window that “slides” open from the taskbar versus snapping open and close somewhere on the desktop; auto-close the on-demand result window when it loses focus (e.g., when a user types or clicks other application windows); hide one or more graphical user interface buttons, such as the persistent query box 330, the options menu 350, or the result controller 340; provide a “sticky” query button which causes the last query type to be remembered and used as the default query type for processing a subsequent query; and the option to select a hotkey for opening or closing the on-demand result window.

It will be appreciated that in alternative embodiments, additional or less configuration or query type options may be provided. Furthermore, in one embodiment, instead of or in addition to displaying an options menu icon 350 on the taskbar or elsewhere on a desktop from which a user accesses the configuration and/or query type options, a right mouse click or hotkey may provide access to one or more options menus. Furthermore, in one embodiment of the invention, the various query options may be configurable by a user, such that a user could add or delete various query options, select query processing mechanisms (e.g., what search mechanism to use to process a particular query type), etc.

FIG. 3B is a diagram of the exemplary user interface shown in FIG. 3A, further including an on-demand, on-demand result window, according to one embodiment of the invention. In FIG. 3B, the desktop 300 is shown displaying an on-demand result window 360. The on-demand result window 360 may provide one or more browser functionalities (e.g., back/forward button, favorites, etc.), and of course, display the result(s) returned in response to a query request received in the persistent query box 330. Such navigational/browser functionalities may be provided by one or more icons or menus displayed or otherwise provided by or in association with the on-demand result window 360.

In one embodiment of the invention, the on-demand result window 360 is a pop-up window that slides open from the taskbar 320 onto the desktop 300 and displays a result(s) returned responsive to a query requested via the persistent query box 330 or some other user input that toggles display thereof (e.g., click on an icon, hovering over the persistent search box, entry of a hotkey, etc.). Optionally, a user may have the on-demand result window snap open or closed elsewhere on the desktop and be able to move it around the desktop. The on-demand result window 360 may also be resized using a resize controller icon 370. In one embodiment, the on-demand result window 360 is only displayed in response to a query command received in the persistent query box 330, and is closed (i.e., not displayed) when a user clicks, types or otherwise indicates activity in another window, icon, etc. (i.e., when the on-demand result window 360 is not in focus). In one embodiment, the on-demand result window is generated as an instance of a (default) browser program, such as Internet Explorer, Opera, or Netscape Navigator or some other browser program that may be present on the client system. In one embodiment, the on-demand window, as an instance of a browser program, provides only a subset of the set of navigational functionality provided by the browser program's window. For example, in one embodiment as implemented using the Internet Explorer browser program, the on-demand window provides forward and back functionality only for browsing documents; history, refresh/reload, stop load, favorites, and other functionality provided by the default or “normal” browser window of the browser program are not provided via the on-demand window. Furthermore, the on-demand window may be reformatted relative the default browser window, e.g., to reduce the size of a result displayed therein and thus allow more information to be displayed therein or a relatively smaller result window to display information relative to the default browser window.

The on-demand result window 360 may include one or more icons for providing various functionality for displaying and navigating query results, document content, or other information. For example, a window resize controller 370 provides grab-and-drag resizing of the on-demand result window 360. One or more icons may be included in a navigation controller 380 that provide browser functionality, such as moving backward and forward, refreshing, or otherwise navigating results, documents, etc., displayed in the window 360. In one embodiment, the navigation controller includes an icon that, when selected, launches a default browser program in which to display a current/selected result, document, etc., and to allow a greater amount of navigational functionality to be accessed thereby.

In one embodiment, HTML content is reformatted for display in the on-demand result window 360. For example, in one embodiment, the size of the on-demand result window 360 is maintained relatively small by reducing font size when displaying HTML documents therein, thereby minimizing the use of display resources by the on-demand result window 360 while allowing a substantial amount of information to be viewable therein.

### Exemplary Processing

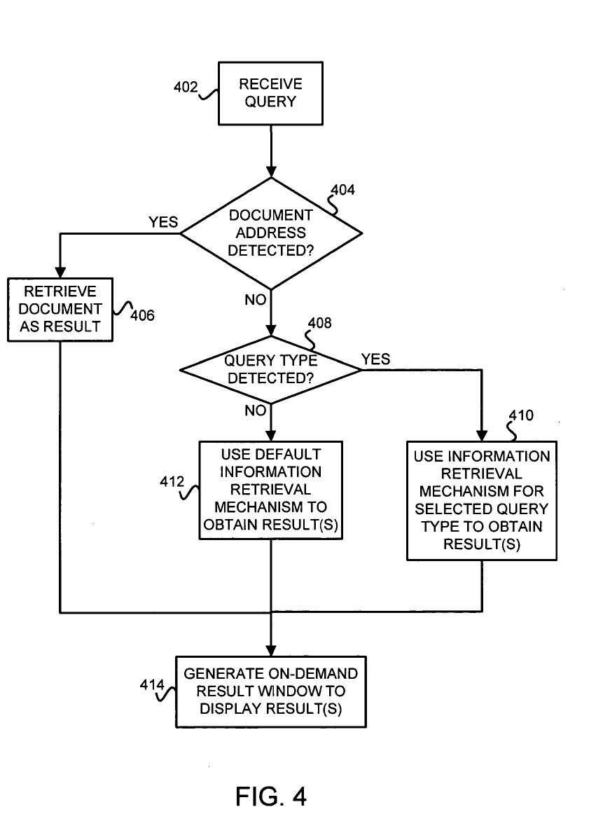

FIGS. 4 is a flow diagram of a method for providing a persistent query area and on-demand result window (collectively, an “on-demand information retrieval interface” or simply “IR interface”) for a computer user interface, in accordance with one embodiment of the invention.

At act 402, the on-demand query interface receives a (user) query that includes one or more terms input to a persistent query box and a command to request information retrieval. The query terms could be typed, copied or “captured” in the persistent query box (e.g., for the latter, using a global search hotkey(s) to automatically capture text typed in virtually any application or file and immediately enter it into the persistent query box 330). In one embodiment, there may be no persistent query box or the query box may only appear on-demand (e.g., using a hotkey), and a user may request a query simply by using a hotkey to capture text (e.g., a recently typed string) in any application as a query. The hotkey may specify a particular search type, or a default search type may be performed on the captured text. Moreover, the captured text may be selected automatically (e.g., the system may use recently typed text, e.g., a word or phrase or other character string) and/or a user may highlight text it wishes to be used to run the query.

At act 404, the query terms (also referred to herein as “search terms”) are analyzed to determine if a specific document request is detected. For example, if a specific URL (a query beginning with the text, “http://” or “https://” or “ftp://”), domain (e.g., query text ending in a top level domain indicator, such as “.com” or “.org” or “.edu” or some other known root domain) or other specific non-search query is detected, then at act 406, that particular document is retrieved as a result.

Otherwise, at act 408, it is determined whether a particular query type is selected. As mentioned above, a query type may include, for example, one or a combination of a general web search, an intranet/LAN search, a stock quote, news search, product search, a (local) weather report, a dictionary/thesaurus/glossary search, software downloads search, movie show time/review search, image search (e.g., via Google image search), a first result search return (e.g., the “I'm Feeling Lucky” option of a Google search provided at www.google.com), etc. The user may use keyboard shortcut or “hotkey” (which may be predefined and/or set by the user) to select a search type and/or may select a search type from a pull down menu provided via an icon on the desktop, a right mouse click or some other mechanism.

If so, then at act 410, an information retrieval mechanism suitable for processing the selected query type is used to handle the query. For example, if a general web search has been selected as a query type, a general web search engine (e.g., as provided at www.google.com) may be used to process the query. On the other hand, if a product search query type is selected, then a product-related information retrieval mechanism (e.g., ebay.com or froogle.com) may be used to process the query and provide a relevant (product-related) result(s). Each information retrieval mechanism may reside at one or more server systems, such as the server systems 120-140 shown in FIG. 1.

In one embodiment, if a particular query type is not detected at act 408, then at act 412, a default query type will control processing of the query and obtaining a result. In one embodiment, the default query type is a general web search using a general web search engine and the result(s) include one or more links to web documents determined to be relevant by the particular web search engine. In one embodiment, the default query type may be selected by a user. In another embodiment, the default query type is predefined.

At act 414, an on-demand result window is generated and the result(s) obtain in act 406, 410 or 412 is output using the on-demand result window.

### CONCLUSION

Thus, in accordance with one aspect, the present invention allows queries to be input and processed directly from a persistent or on-demand query input area, without the need to open a browser or other program separately for entering/processing a query, navigating to a search engine or particular document, etc. A number of query types may be supported by the user interface of the present invention, such that depending on a particular query type selected for/indicated by a query, a particular information retrieval mechanism processes the query to obtain one or more results. In accordance with another aspect, on-demand (i.e., hidden when not use) result window is generated in response to a query request to output one or more results obtained in response to a given query, and optionally is hidden when a user accesses other windows, functionality, etc.˜i.e., when the result window loses focus. In accordance with yet another aspect of the invention, a fill-in query box or other input area (e.g., a navigation bar of a browser, a persistent query box, etc.) may display static or dynamic information when not in focus.

### General

It should be appreciated that reference throughout this specification to “one embodiment” or “an embodiment” or “an aspect” of the invention means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” or “an aspect” in various portions of this specification are NOT necessarily all referring to the same embodiment. Furthermore, the particular features, structures or characteristics of one or more embodiments or aspects described may be combined or implemented independently of each other as suitable in one or more embodiments of the invention.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the present invention is not limiting of the present invention. Thus, the operation and behavior of the aspects were described without reference to the specific software code—it being understood that a person of ordinary skill in the art would be able to design software and control hardware to implement the aspects based on the description herein.

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used. The term “or” means “and/or”.

It should further be appreciated that, in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims (also as such may be amended, reissued, etc., from time to time) are hereby expressly incorporated into this Detailed Description, with each claim standing on its own as a separate embodiment of this invention.

What is claimed is:

1. A computer-implemented method comprising:
providing a web query toolbar in a desktop environment of a client device, the web query toolbar including a query box control;
receiving one or more query terms input to the query box control;
receiving input from a user of the client device, the input indicating a selection of a desired query type from a set of multiple query types, and further indicating that a web query of the desired query type should be executed using the input query terms;
transmitting to a search engine instructions to execute the web query of the desired query type using input query terms;
receiving a result of the web query from the search engine;
animating a results window to appear to slide open from the web query toolbar based on receiving the result of the web query; and
providing the result of the web query in the results window.

2. The computer-implemented method of claim 1, wherein the one or more query terms are manually input to the query box control by the user.

3. The computer-implemented method of claim 1, wherein:
the input further indicates that text typed into an application executing in the desktop environment of the client device should be input into the query box control as the one or more query terms, and
receiving the one or more query terms further comprises inputting the text typed into the application into the query box control as the one or more query terms.

4. The computer-implemented method of claim 3, wherein the text typed into the application further comprises a most recently typed word, phrase or other character string typed into the application by the user.

5. The computer-implemented method of claim 1, further comprising displaying an advertisement, animation or video within the query box control prior to receiving the one or more query terms.

6. The computer-implemented method of claim 1, further comprising:
determining that a focus of the user is no longer detected at the web query toolbar or the results window; and
animating the results window to appear to slide closed into the web query toolbar based on determining that the focus of the user no longer detected at the web query toolbar or the results window.

7. The computer-implemented method of claim 1, wherein the set of multiple query types includes two or more query types selected from the group consisting of a mapping query, a weather query, a software download query, a movie review query, a movie show time query, a product query, a stock quote query, a dictionary query, a thesaurus query, an image query, and a user group query.

8. The computer-implemented method of claim 1, wherein:
the desired query type comprises a combined query type representation a combination of two or more different query sub-types, and
each query sub-type is selected from the group consisting of a general web search query, a mapping query, a weather query, a software download query, a movie review query, a movie show time query, a product query, a stock quote query, a dictionary query, a thesaurus query, an image query, and a user group query.

9. The computer-implemented method of claim 1, further comprising:
determining that the query box control has changed focus, either from out-of-focus to in-focus, or from in-focus to out-of-focus;
determining size that the user has predefined for the changed focus; and
resizing the query box control to match the size predefined by the user.

10. The computer-implemented method of claim 1, wherein the results window is not a browser instance.

11. The computer-implemented method of claim 1, wherein the desired query type further comprises a default query type or a last-used query type.

12. The computer-implemented method of claim 1, further comprising:
determining query types authorized by an administrator for the user or for a domain associated with the client device;
displaying information identifying the query types on the web query toolbar; and
receiving a selection of one of the authorized query types, as the desired query type, from the user.

13. The computer-implemented method of claim 1, further comprising:
receiving a first keyboard shortcut from the user indicating that text typed into an application executing in the desktop environment of the client device should be input into the query box control as the one or more query terms; and
receiving a second keyboard shortcut from the user identifying the desired query type.

14. The computer-implemented method of claim 1, further comprising:
determining that the one or more query terms do not uniquely identify a specific resource,
wherein the instructions are transmitted to the search engine based on determining that the one or more query terms do not uniquely identify the specific resource.

15. A system comprising:
one or more computers; and
a computer-readable medium coupled to the one or more computers having instructions stored thereon which, when executed by the one or more computers, cause the one or more computers to perform operations comprising:
providing a web query toolbar in a desktop environment of a client device, the web query toolbar including a query box control,
receiving one or more query terms input to the query box control,
receiving input from a user of the client device, the input indicating a selection of a desired query type from a set of multiple query types, and further indicating that a web query of the desired query type should be executed using the input query terms,
transmitting instructions to a search engine to execute the web query of the desired query type using input query terms,
receiving a result of the web query from the search engine,
animating a results window to appear to slide open from the web query toolbar based on receiving the result of the web query, and
providing the result of the web query in the results window.

16. The system of claim 15, wherein:
the input further indicates that text typed into an application executing in the desktop environment of the client device should be input into the query box control as the one or more query terms, and
receiving the one or more query terms further comprises inputting the text typed into the application into the query box control as the one or more query terms.

17. The system of claim 15, wherein the operations further comprise:
determining that a focus of the user is no longer detected at web query toolbar or the results window; and
animating the results window to appear to slide closed into the web query toolbar based on determining that the focus of the user no longer detected at the web query toolbar or the results window.

18. A computer storage medium encoded with a computer program, the program comprising instructions that when executed by data processing apparatus cause the data processing apparatus to perform operations comprising:
providing a web query toolbar in a desktop environment of a client device, the web query toolbar including a query box control;
receiving one or more query terms input to the query box control;
receiving input from a user of the client device, the input indicating a selection of a desired query type from a set of multiple query types, and further indicating that a web query of the desired query type should be executed using the input query terms;
transmitting instructions to a search engine to execute the web query of the desired query type using input query terms;
receiving a result of the web query from the search engine;
animating a results window to appear to slide open from the web query toolbar based on receiving the result of the web query; and
providing the result of the web query in the results window.

19. The computer storage medium of claim 18, wherein:
the input further indicates that text typed into an application executing in the desktop environment of the client device should be input into the query box control as the one or more query terms, and
receiving the one or more query terms further comprises inputting the text typed into the application into the query box control as the one or more query terms.

20. The computer storage medium of claim 19, wherein the operations further comprise:
determining that a focus of the user is no longer detected at web query toolbar or the results window; and
animating the results window to appear to slide closed into the web query toolbar based on determining that the focus of the user no longer detected at the web query toolbar or the results window.
